(19) United States
(12) Patent Application Publication
(10) Pub. No.: US 2003/0227427 A1
(43) Pub. Date: Dec. 11, 2003

(54) Plasma display panel

(75) Inventor: Jung-Hun Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/454,622

(22) Filed: Jun. 5, 2003

(30) Foreign Application Priority Data
Jun. 10, 2002 (KR) 32325/2002/

(51) Int. Cl. G09G 3/28

(52) U.S. Cl. 345/60

(57) ABSTRACT

In a PDP capable of preventing distortion and obtaining high brightness and high efficiency, a PDP including plural pixel cells respectively having differently structured three discharge cells includes a first and a second discharge cells formed so as to be adjacent left/right and be corresponded with each other; and a third discharge cell formed so as to have a horizontal length same with a length from the first discharge cell to the second discharge cell and have a vertical length shorter than that of the first and second discharge cells.

### BACKGROUND OF THE INVENTION

1. Field of the Invention

The present invention relates to a PDP (plasma display panel), and in particular to a PDP capable of preventing distortion of images and obtaining high brightness and high efficiency.

2. Description of the Prior Art

Recently, as a next generation digital multimedia display device, various FPDs (flat panel display) have been developed. There are a LCD (liquid crystal display), a FED (field emission display), a PDP (plasma display panel) and an EL (electroluminescence), etc. In particular, because the PDP has many advantages in comparison with other FPDs, it has attracted public attention.

Unlike other FPDs, the PDP is a self-emission display using plasma gas discharge, has a picture quality as good as that of a CRT (cathode ray tube) and can be easily fabricated as a large screen. In more detail, the PDP is mostly expected as a large screen display device having a high picture quality and a large screen. In addition, a three electrode AC surface discharge type PDP is typical, and it is driven by AC voltage.

Hereinafter, a discharge cell of the PDP will be described with reference to accompanying FIG. 1. Herein, a cell for emitting one visible light of R (red), G (green) and B (blue) is called a discharge cell, and a cell consisting of one pixel by including three discharge cells is called a pixel cell.

FIG. 1 is a sectional view illustrating the discharge cell of the PDP in accordance with the conventional art.

As depicted in FIG. 1, by combining a front plate 110 with a back plate 120 and injecting a discharge gas, the discharge cell of the PDP is formed.

The front plate 110 includes an upper glass plate 100; a scan electrode 102Y and a sustain electrode 102Z formed on the upper glass substrate 100; an upper dielectric layer 103 formed on the upper glass substrate 100 and the electrodes 102Y, 102Z in order to store wall charge generated in plasma discharge; and a protection layer 105 formed on the upper dielectric layer 103 in order to prevent the upper dielectric layer 103 from being damaged by ion sputtering occurred in plasma discharge and lower an operating voltage and a sustain voltage of discharge plasma by improving a discharge efficiency of secondary electron.

Herein, the scan electrode 102Y includes a first transparent electrode 102Y1 and a first bus electrode 102Y2, and the sustain electrode 102Z includes a second transparent electrode 102Z1 and a second bus electrode 102Z2. In addition, MgO is generally used for the protection layer 105.

The back plate 120 includes a lower glass plate 101; an address electrode 102X formed on the lower glass substrate 101; a lower dielectric layer 104 coated on the address electrode 102Z; a barrier rib 107 vertically formed on the lower dielectric layer 104 in order to form a discharge space in the discharge cell and prevent cross-talk due to ultraviolet rays and visible rays generated in the discharge space; and a phosphor 106 coated on the surface of the lower dielectric layer 104 and the barrier rib 107 in order to emit one visible light of three primary colors (R, G, B) by being excited by the ultraviolet rays generated in plasma discharge.

In the PDP, the discharge cell arranged as a matrix shape is accessed by using the address electrode 102X and the scan electrode 102Y of the discharge cell, and the accessed discharge cell sustains discharge by surface-discharge between the scan electrode 102Y and the sustain electrode 102Z. Accordingly, in the PDP, the phosphor 106 is excited by ultraviolet rays generated in the sustain discharge, visible rays are discharged from the phosphor 106 to the outside of the cell, and accordingly an image is displayed through the discharge cell arranged as the matrix format. Hereinafter, the barrier rib structure of the PDP in accordance with the conventional art will be described with reference to accompanying FIGS. 2˜6.

FIG. 2 shows a stripe type barrier rib of a PDP in accordance with the conventional art, and FIG. 3 shows a wall type barrier rib of a PDP in accordance with the conventional art.

As depicted in FIG. 2, in a stripe type barrier rib 207, discharge gas can be easily discharge, however, because a coating area of the phosphor is small, brightness may be lowered.

As depicted in FIG. 3, in a wall type barrier rib 307, because a coating area of the phosphor is large, brightness can be improved, however, discharge gas can not be easily discharged.

As described above, in order to solve problems of the stripe type and the wall type barrier rib structures of the PDP, a delta type barrier rib structure has been presented.

FIG. 4 is a plan view illustrating the delta type barrier rib of a PDP in accordance with the conventional art.

As depicted in FIG. 4, the delta type barrier rib structure includes a barrier rib 407A surrounding the discharge cell as a hexahedral shape; and a barrier rib 407B for connecting a discharge space formed by the barrier rib 407A to a channel 408 having small width.

In the PDP having the delta type barrier rib, because the discharge cell is surrounded as the hexahedral shape by the barrier rib, phosphor coating area and barrier rib refractivity are increased, and accordingly brightness can be improved. And, because each discharge cell is connected to the channel 408, discharge and injection of discharge gas can be smoothly performed. In addition, in the delta type barrier rib 407, because a discharge starting voltage of the channel 408 is higher than a discharge starting voltage of the discharge space, it is possible to decrease confusion in barrier rib direction. Herein, contact potential not less than a certain voltage is required for starting discharge between the scan and sustain electrodes, and a voltage as a border is called the discharge starting voltage.

However, in the PDP having the delta type barrier rib structure, because the scan and sustain electrodes 402Y, 402Z have to be arranged symmetrically in all discharge cells, unlike other barrier rib structures, the bus electrode 402Y2 is arranged at the center of the transparent electrode 402Y1. Accordingly, visible rays discharged from each discharge cell is shielded by the bus electrode 402Y2, and brightness is decreased as much as the shielded visible rays.

FIG. 5 is a plan view illustrating scan and sustain electrodes of a PDP having a quadrangular-delta type barrier rib structure in accordance with the conventional art, and FIG. 6 is a plan view illustrating an address electrode of the PDP having the quadrangular-delta type barrier rib structure in accordance with the conventional art.

As depicted in FIG. 5, the PDP having the quadrangular-delta type barrier rib structure includes a scan electrode 502Y having a first bus electrode 502Y2, and a first transparent electrode 502Y1 extended from the first bus electrode 502Y2; a sustain electrode 502Z having a second bus electrode 502Z2 and a second transparent electrode 502Z1 extended from the second bus electrode 502Z2; and a quadrangular-delta type barrier rib 507 having a first barrier rib 507A formed side by side with the first bus electrode 502Y2 and a second barrier rib 507B formed in the cross direction of the first barrier rib 507A so as to be connected with the first barrier rib 507A.

As depicted in FIG. 6, the PDP address electrode 602X having the quadrangular-delta type barrier rib structure 607 includes an address electrode 602X1 widely formed so as to be corresponded to the discharge space formed by the quadrangular-delta type barrier rib 607; and an address electrode 602X2 having a narrow width so as to be connected with the widely formed address electrode 602X1.

As described above, in the PDP having the quadrangular-delta type barrier rib structure, because the discharge cell is surrounded as a quadrangular shape by the quadrangular-delta type barrier rib 607, a phosphor coating area is increased, barrier rib refractivity is increased, and accordingly brightness can be improved.

However, in the PDP having the quadrangular-delta type barrier rib structure, because each discharge cell is formed as not a matrix shape but a zigzag shape, it is difficult to describe a straight line. Accordingly, images of the PDP may be distorted. In addition, because a size of each cell is regular, it may be difficult to adjust a color temperature.

As described above, in the PDP having the quadrangular-delta type barrier rib structure, because the discharge cell has the quadrangular shape, it has discharge efficiency lower than that of a square shape. In addition, in the delta shape and the quadrangular-delta type barrier rib structures, because discharge cells have the same size, it is difficult to adjust a color temperature and brightness, because discharge cells are formed as a zigzag shape, when a straight line is described on the PDP, picture quality lowering phenomenon may occur. The PDP in accordance with the conventional art has fundamental problems related to distortion, brightness and efficiency lowering.

### SUMMARY OF THE INVENTION

In order to solve the above-mentioned problems, it is an object of the present invention to provide a PDP capable of preventing distortion of images of a PDP by forming differently structures of discharge cells respectively formed in pixel cells.

It is another object of the present invention to provide a PDP capable of improving brightness of a PDP by forming differently structures of discharge cells formed in pixel cells.

It is yet another object of the present invention to provide a PDP capable of improving efficiency of a PDP by forming differently structures of discharge cells formed in pixel cells.

In order to achieve the above-mentioned objects, a PDP (plasma display panel) in accordance with the present invention includes plural pixel cells respectively having differently structured three discharge cells.

In order to achieve the above-mentioned objects, in a PDP including plural pixel cells respectively having differently structured three discharge cells, a PDP includes a first and a second discharge cells formed so as to be corresponded with each other; and a third discharge cell formed so as to have a horizontal length same with a length from the first discharge cell to the second discharge cell and have a vertical length shorter than that of the first and second discharge cells.

Other objects and characteristics will be described clearly with reference to accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view illustrating a structure of a discharge cell of a PDP in accordance with the conventional art;

FIG. 2 shows a stripe type barrier rib of the PDP in accordance with the conventional art;

FIG. 3 shows a wall type barrier rib of the PDP in accordance with the conventional art;

FIG. 4 is a plan view illustrating a delta type barrier rib of the PDP in accordance with the conventional art;

FIG. 5 is a plan view illustrating scan and sustain electrodes of a PDP having a quadrangular-delta type barrier rib structure in accordance with the conventional art;

FIG. 6 is a plan view illustrating an address electrode of the PDP having the quadrangular-delta type barrier rib structure in accordance with the conventional art.

FIG. 7 is a plan view illustrating a barrier rib structure of a PDP in accordance with the present invention;

FIG. 8 is a plan view illustrating an electrode structure of a PDP in accordance with the present invention; and

FIGS. 9A and 9B are sectional views illustrating a structure of a discharge cell of a PDP in accordance with the present invention.

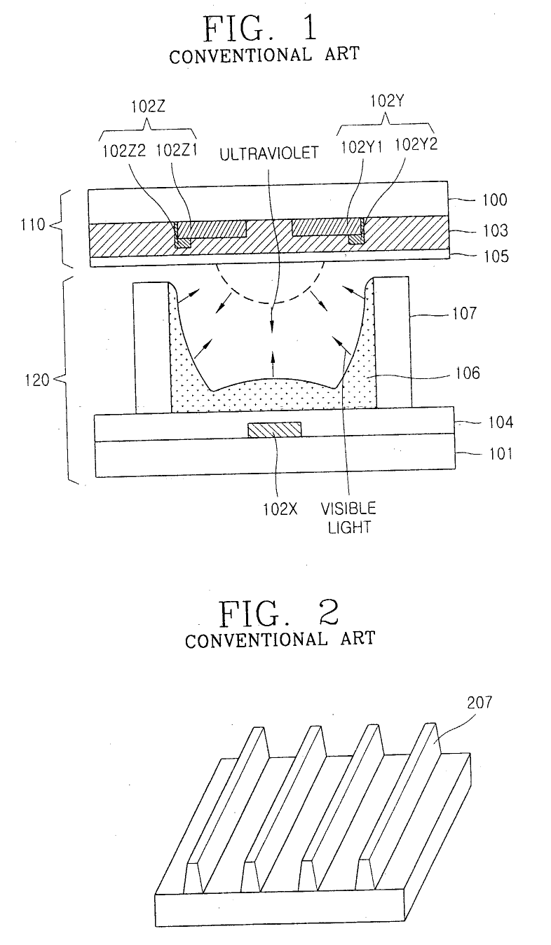

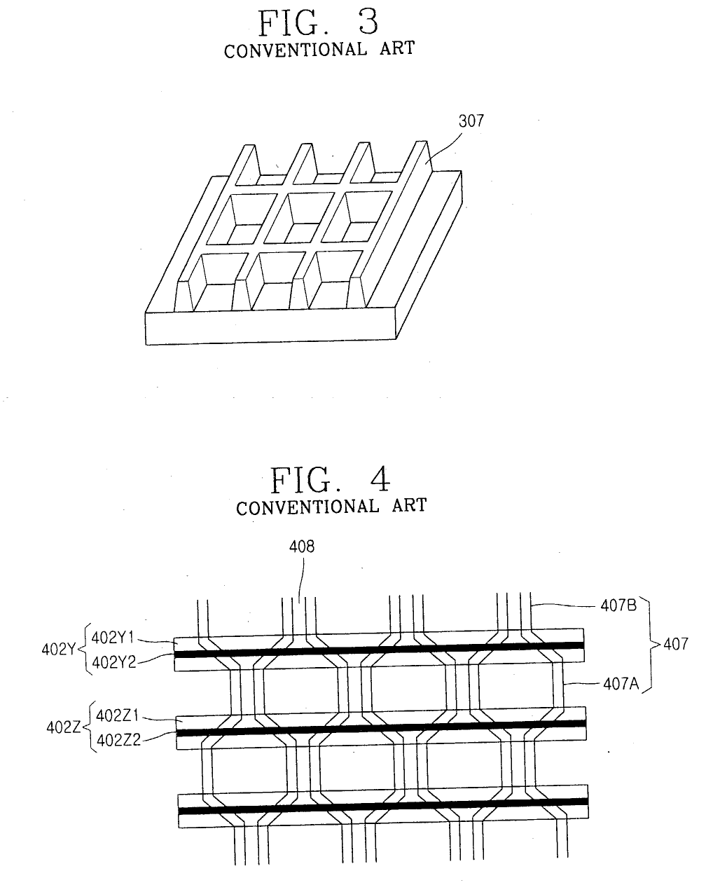

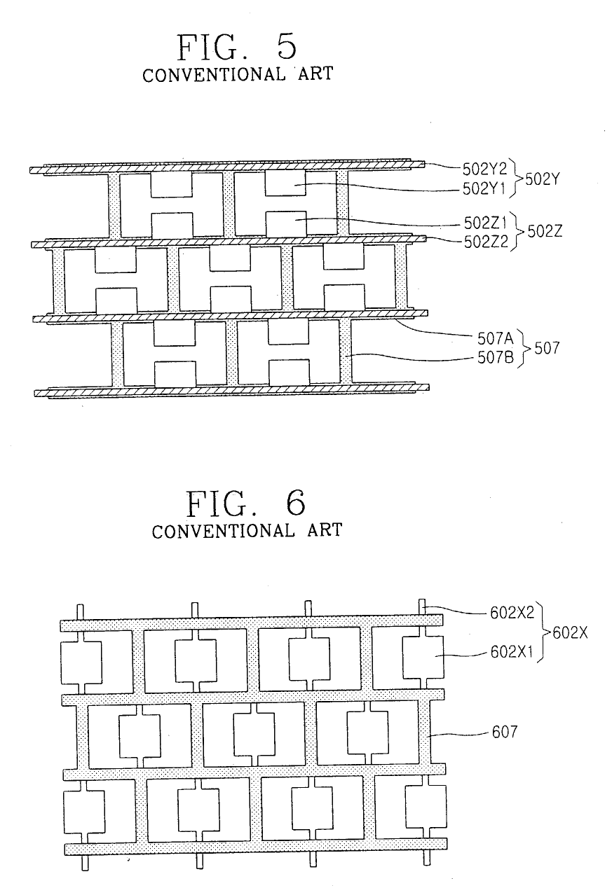

### DETAILED DESCRIPTION OF THE PREFERRED EMBODIMENT

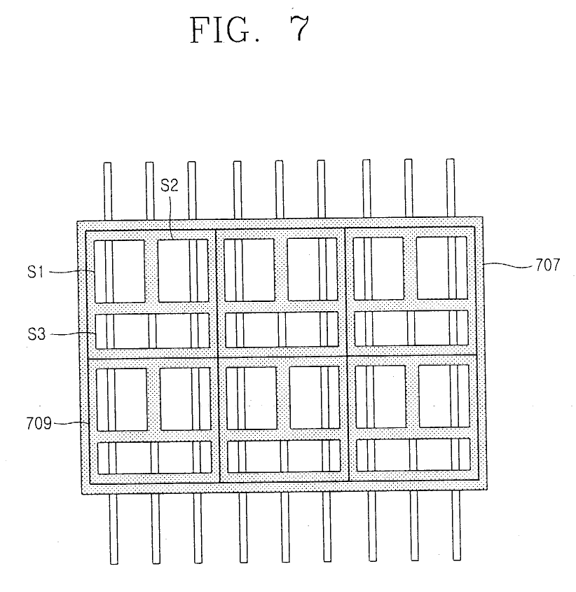

Hereinafter, the preferred embodiments of a PDP capable of preventing distortion, improving brightness and bettering efficiency by differently forming structures of discharge cells formed in pixel cells will be described with reference to accompanying FIGS. 7˜9B.

FIG. 7 is a plan view illustrating a barrier rib structure of a PDP in accordance with the present invention.

As depicted in FIG. 7, in the PDP having plural pixel cells respectively having a discharge cell having a structure different from each other, the pixel cell 709 includes a first and a second discharge cells S1, S2 formed so as to be corresponded with each other as left/right; a third discharge cell S3 formed below the two discharge cells S1, S2 so as to have a longer horizontal length and a shorter vertical length than those of the two discharge cells; and a quadrangular barrier rib 707 formed so as to surround the first, second and third discharge cells S1, S2, S3 in order to prevent cross-talk with adjacent discharge cells and form a discharge space. Herein, it is preferable to form the pixel cell 709 as a square shape in order to improve discharge efficiency.

Because the first, second and third discharge cells S1, S2, S3 have different shapes, an electrode arranged in each discharge cell is differently formed.

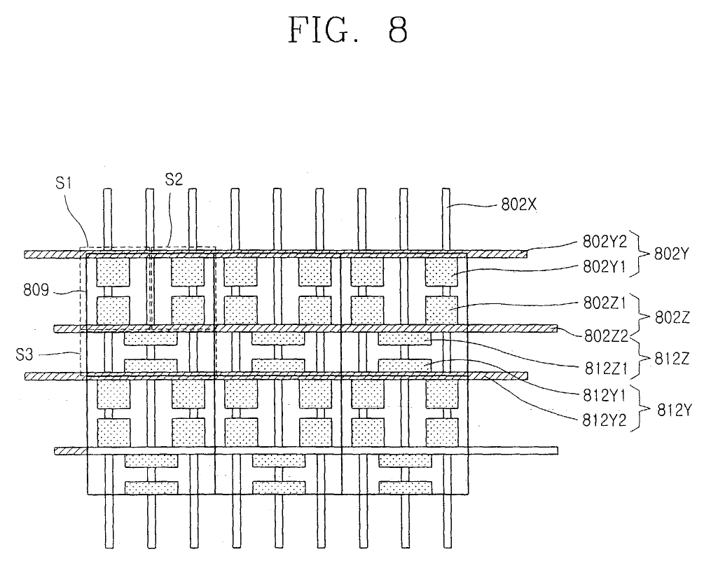

FIG. 8 is a plan view illustrating an electrode structure of a PDP in accordance with the present invention.

As depicted in FIG. 8, in the PDP having plural pixel cells respectively having differently shaped-discharge cells, the first and second discharge cell respectively include a bus electrode 802Y2, 802Z2; a transparent electrode 802Y1, 802Z1 extended from the bus electrode 802Y2, 802Z2 so as to be corresponded to it; and an address electrode 802X crossed the bus electrode 802Y2, 802Z2 and overlapped with the transparent electrode 802Y1, 802Z1. On the other hand, the third discharge cell S3 includes bus electrodes 802Z2, 812Y2; a transparent electrode 812Y1, 812Z1 extended from the bus electrode 802Z2, 812Y2 so as to be corresponded to it; and an address electrode 802X crossed the bus electrode 802Z2, 812Y2 and overlapped with the transparent electrode 812Y1, 812Z1. Herein, the transparent electrodes 812Y1, 812Z1 of the third discharge cell have a longer horizontal length and a shorter vertical length than those of the transparent electrodes 802Y1, 802Z1 formed on the first and second discharge cells S1, S2.

As described above, in one pixel cell, because the third discharge cell S3 has a size different from that of the first and second discharge cells S1, S2, a size of the transparent electrodes 812Y1, 812Z1 formed in each discharge cell is different from that of the transparent electrodes 802Y1, 802Z1. Herein, the address electrode 802X is jointly owned by the discharge cells adjacent up and down. However, in the third discharge cell S3, a horizontal length of the transparent electrodes 812Y1, 812Z1 is limited so as to prevent miss discharge occurrence between the address electrode 802X passing the first and third discharge cells S1, S3 and the second/third discharge cells S2, S3. Accordingly, the address electrode 802X has to be patterned appropriately in order to prevent the miss discharge occurrence.

The transparent electrode 802Y1, 802Z1, 812Y1, 812Z1 is made of a transparent conductive material having light transmittivity not less than 90%, for example, indium tin oxide, etc. However, because the transparent electrode 802Y1, 802Z1, 812Y1, 812Z1 has low conductivity, the bus electrode 802Y2, 802Z2, 812Y2 is made of a metal material having high electric conductivity in order to compensate resistance element. Accordingly, preferably bus electrode 802Y2, 802Z2, 812Y2 has a small width and is made of a metal material having high electric conductivity such as Ag or Cu.

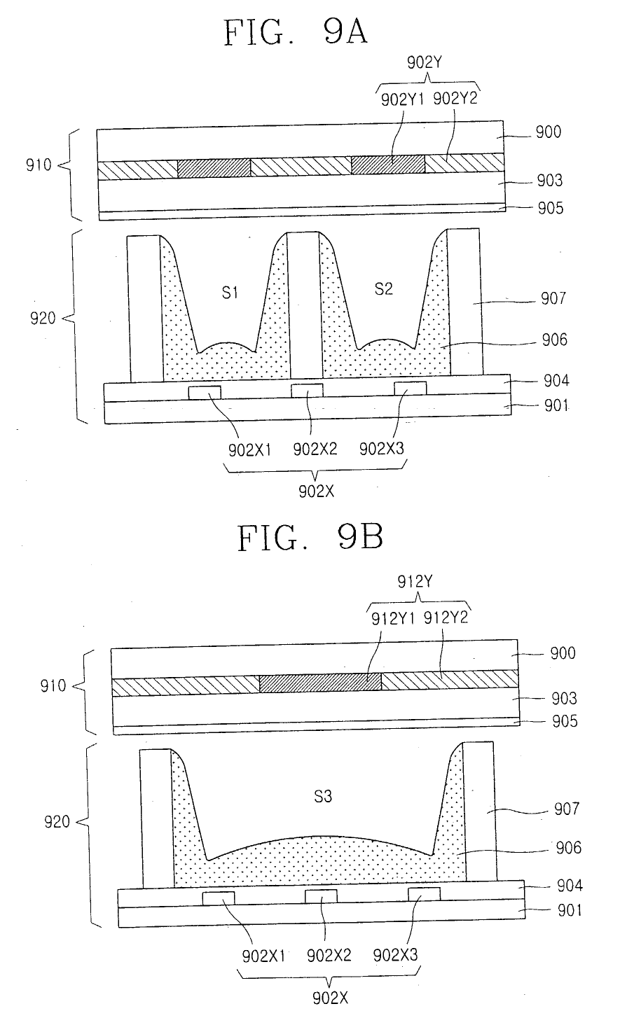

FIGS. 9A and 9B are sectional views illustrating a structure of a discharge cell of a PDP in accordance with the present invention.

FIG. 9A is a sectional view illustrating the first and second discharge cells of the PDP in accordance with the present invention; and FIG. 9B is a sectional view illustrating the third discharge cell of the PDP in accordance with the present invention.

As depicted in FIG. 9A, a front plate 910 of the first and second discharge cells S1, S2 includes an upper glass substrate 900; a scan electrode 902Y and a sustain electrode (not shown) formed on the top surface of the upper glass substrate 900; an upper dielectric layer 903 formed on the upper glass substrate 900, the scan electrode 902Y and the sustain electrode in order to store wall charge generated in plasma discharge; and a protection layer 905 formed on the upper dielectric layer 903 in order to increase life-span of the PDP by preventing damage of the upper dielectric layer 903 from ion sputtering occurred in plasma discharge and lower a driving voltage and a sustain voltage of discharge plasma by improving a discharge efficiency of secondary electron.

Herein, the scan electrode 902Y and the sustain electrode (not shown) include a bus electrode 902Y2 having a horizontally long length; and a transparent electrode 902Y1 extended from the bus electrode 902Y2 and having a horizontal length shorter than that of the bus electrode 902Y2.

A back plate 920 of the first and second discharge cells S1, S2 includes a lower glass substrate 901; an address electrode 902X formed on the lower glass substrate 901; a lower dielectric layer 904 coated on the lower glass substrate 901 having the address electrode 902X; a barrier rib 907 formed on the lower dielectric layer 904 in order to form a discharge space and prevent cross-talk due to ultraviolet and visible rays generated in the discharge space; and a phosphor 906 coated on the surface of the lower dielectric layer 904 and the barrier rib 907 in order to emit one visible ray of three primary colors as R, G, B by being excited by the ultra violet light generated in plasma discharge. Herein, the address electrode 902X1 of the first discharge cell S1 is formed toward left of the discharge space so as to be corresponded to the transparent electrode 902Y1, and the address electrode 902X3 of the second discharge cell S2 is formed toward right of the discharge space so as to be corresponded to the transparent electrode 902Y1. In addition, the other address electrode 902X2 is formed side by side with the barrier rib 907 so as not to occur miss discharge with the transparent electrode 902Y1.

And, by combining the front and back plates 910, 920 and injecting a discharge gas, the first and second discharge cells S1, S2 of the PDP in accordance with the present invention is formed.

As depicted in FIG. 9B, a front plate of the third discharge cell S3 includes an upper glass substrate 900; a scan electrode 912Y and a sustain electrode (not shown) formed on the upper glass substrate 900; an upper dielectric layer 903 formed on the scan electrode 912Y and the sustain electrode in order to store electric charge in plasma discharge; and a protection layer 905 formed on the upper dielectric layer 903 in order to increase life-span of the PDP by preventing damage of the upper dielectric layer 903 from ion sputtering occurred in plasma discharge and lower a driving voltage and a sustain voltage of discharge plasma by improving a discharge efficiency of secondary electron.

Herein, the scan electrode 902Y and the sustain electrode (not shown) include a bus electrode 912Y2 having a horizontally long length; and a transparent electrode 912Y1 extended from the bus electrode 912Y2 and having a horizontal length shorter than that of the transparent electrode 902Y1 of the first and second discharge cells S1, S2.

A back plate of the third discharge cell S3 includes a lower glass substrate 901; an address electrode 902X formed on the lower glass substrate 901; a lower dielectric layer 904 coated on the lower glass substrate 901 having the address electrode 902X; a barrier rib 907 formed on the lower dielectric layer 904 in order to form a discharge space and prevent cross-talk due to ultraviolet and visible rays generated in the discharge space; and a phosphor 906 coated on the surface of the lower dielectric layer 904 and the barrier rib 907 in order to emit one visible ray of three primary colors as R, G, B by being excited by the ultra violet light generated in plasma discharge.

Herein, in the third discharge cell, there are three address electrodes 902X on the lower glass substrate 901. One address electrode 902X2 is corresponded to the center of the transparent electrode 912Y1, and the rest two address electrodes 902X1, 902X3 are respectively formed in spaces corresponded to between the transparent electrode 912Y1 and the barrier rib 907 so as not to be corresponded to the transparent electrode 912Y1. Herein, the two address electrodes 902X1, 902X3 respectively co-owned between the first and third discharge cells S1, S3 and between the second and third discharge cells S2, S3.

And, by combining the front and back plates 910, 920 and injecting a discharge gas, the third discharge cell S3 of the PDP in accordance with the present invention is formed.

As described above, in the PDP including plural pixel cells respectively having differently structured discharge cells in accordance with the present invention, it is possible to have a structure capable of combining-obtaining advantageous of PDPs in accordance with the conventional art. In more detail, it is possible to solve problems related to distortion, brightness and efficiency lowering occurred in the conventional art.

In the PDP including plural pixel cells respectively having differently structured discharge cells in accordance with the present invention, unlike the conventional art, among three discharge cells consisting of one pixel cell, one discharge cell has a longer horizontal length and a shorter vertical length in comparison with the rest two discharge cells. Accordingly, unlike the delta and the quadrangular-delta type barrier rib structures having the same discharge cell size, in the present invention, discharge cells have different sizes, and accordingly it is possible to adjust a color temperature and improve brightness.

In the PDP including plural pixel cells respectively having differently structured discharge cells in accordance with the present invention, unlike the delta and the quadrangular-delta type barrier rib structures having the zigzag shape, because pixel cells are arranged as a certain matrix shape, in describing of a straight line on the PDP, distortion phenomenon can be prevented.

In addition, in the PDP including plural pixel cells respectively having differently structured discharge cells in accordance with the present invention, a shape of each cell is similar to a square shape in comparison with a discharge cell of a stripe type barrier rib structure, and accordingly discharge efficiency can be improved.

In addition, a barrier rib fabrication method and a driving method are the same with those of the stripe type and wall type structure, and accordingly it is possible improve brightness and efficiency without additional processes.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A PDP (plasma display panel), comprising plural pixel cells respectively including differently structured three discharge cells.

2. The PDP of claim 1, wherein the discharge cell has an address electrode co-owned between discharge cells adjacent up/down in one pixel cell.

3. The PDP of claim 2, wherein the address electrode is overlapped with two transparent electrodes formed in the one discharge cell.

4. In a PDP including plural pixel cells respectively having differently structured three discharge cells, a PDP, comprising:
a first and a second discharge cells formed so as to be corresponded with each other; and
a third discharge cell formed so as to have a horizontal length same with a length from the first discharge cell to the second discharge cell and have a vertical length shorter than that of the first and second discharge cells.

5. The PDP of claim 4, wherein the pixel cell including the first, second and third discharge cells is a square.

6. The PDP of claim 4, wherein the first and second discharge cells consist of a bus electrode and a transparent electrode extended from the bus electrode so as to be corresponded and be adjacent up/down.

7. The PDP of claim 4, wherein the third discharge cell includes a bus electrode and a transparent electrode extended from the bus electrode so as to have a longer horizontal length and have a shorter vertical length than those of scan and sustain electrodes of the first and second discharge cells.

8. The PDP of claim 4, wherein the first, second and third discharge cells are surrounded by a quadrangular-barrier rib.

9. The PDP of claim 4, wherein the pixel cell includes a first and a second discharge cells adjacent left/right with each other and a third discharge cell adjacent up/down to the two discharge cells.
